(19) United States
(12) Patent Application Publication
(10) Pub. No.: US 2007/0112635 A1
(43) Pub. Date: May 17, 2007

(54) System and method for monitoring, aggregation and presentation of product prices collected from multiple electronic marketplaces

(76) Inventor: Sanjin Loncaric, Jersey City, NJ (US)

Correspondence Address: Mr. Sanjin Loncaric, Apt. 10, 108 Sussex Street, Jersey City, NJ, 07302, US

(21) Appl. No.: 11/273,153

(22) Filed: Nov. 14, 2005

(51) Int. Cl. G06Q 30/00

(52) U.S. Cl. 705/26

(57) ABSTRACT

The present invention relates to a method of monitoring, aggregation and presentation of prices listed for products in multiple electronic marketplaces. Specifically, the present invention allows for stock-like monitoring of product prices over a time period and across multiple electronic marketplaces. The resulting display of product price trends provides potential buyers and sellers with insight into the fair value of a product and the power to make their buying or selling decisions.

### CROSS-REFERENCE TO RELATED APPLICATIONS

Not Applicable

### Statement Regarding Federally Sponsored Research or Development

Not Applicable

### Reference to Sequence Listing, a Table, or a Computer Program Listing Compact Disc Appendix

Not Applicable

### Field of the Invention

The present invention relates to the field of electronic marketplaces, such as person to person listing services or online auction services, and providing the ability to query and display prices for products that are listed in multiple electronic marketplaces.

### BACKGROUND OF THE INVENTION

Stock charts are well known. They are listed in electronic and printed publications and have become a familiar tool and source of information for investors. Similarly, representing product prices over time via charts, graphs and other visual aides is also common (one can easily imagine a graph representing gas prices over the last 10 years). However, retail product prices have never been volatile enough in the past to warrant a need to monitor them in a stock-like manner. Besides, finding out historical prices for a product can be a challenging task requiring time and access to multiple retail vendors.

The advent of electronic marketplaces challenged these assumptions. The electronic marketplace services that started appearing in late nineties and early 2000's introduced price volatility in common goods by the fact that the prices were being set by users of these services themselves. Therefore, the price for each product listed would fluctuate as the users' perceptions of the products' supply and demand changed. The electronic services also provided the ability to get the most recent product “price quote” quickly and easily—all one had to do was to enter the product keywords in the search textbox on the website of the electronic marketplace. The ensuing popularity of electronic marketplaces resulted in a large number of individuals and small businesses that started forming business processes around the ability to buy and sell products using the tools and services provided by the various electronic marketplaces. This in turn, made the product prices not only volatile, but also volatile in every electronic marketplace in which products were listed. Therefore, the presentation of retail product prices in a stock-like manner has not only become natural, but has also become expected from both seller and buyer alike.

It is believed that the electronic marketplaces have become the driver of baseline prices that consumers are willing to pay for any given product. Due to their marketplace nature they provide consumers with confidence that the price they are paying is low and fair. In addition, by being online, they are also readily accessible and convenient. For the users of the electronic marketplaces this avoids the hassle of going to the local mall comparing prices from one store to another or even visiting multiple web site storefronts. However, with multiple electronic marketplaces now in existence both sellers and buyers would benefit from a consolidated price view for a product of interest. In addition they would also benefit o understand the price trends over time in each of the electronic marketplaces.

The present invention aims to provide that consolidated view, which in turn aims to provide answers to commonly asked questions by both buyers and sellers. For buyers these questions are usually:
Am I getting the lowest price for a product?
Is this the right time to buy a product or should I wait?
Where can I get the lowest price?
   For sellers these questions are usually:
Where can I make the most on the sale of my products?
Is this the right time to sell my product or should I wait?

### BRIEF SUMMARY OF THE INVENTION

The term “electronic marketplace” as used in the description of the present invention is defined as any service that allows its users to list products for sale as well as purchase the products listed for sale by other users. It includes auction based services as well as mediated (where additional listing tools and services like online payments and search rankings are available and where listing fees or sale fees are imposed) and non-mediated (similar to a classifieds service where few additional services exist and where there are no fees imposed) product listing services.

In one embodiment of the present invention, each electronic marketplace is assigned its own customized set of monitoring and interpreting rules. Further, each electronic marketplace is assigned a priority that defines the order of monitoring. The electronic marketplace that is assigned a highest priority will be used to also define the list of products that are being monitored. The monitoring cycles occur in regular time intervals that are configurable. Each interval all specified electronic marketplaces are queries in the order of priority at least once for all products being monitored.

The methods of monitoring can vary for each electronic marketplace and may include, but are not limited to, such methods as: API calls, web service calls, RSS feeds, screen scraping and human entry. During a particular monitoring cycle the prices are interpreted based on the rule set defined for that marketplace and are then recorded in a central database. Additional information such as marketplace name, price timestamps, product links, user reviews, listing fees, shipping costs etc. may also be recorded along with the price quotes. The collected information is kept in the central database for an extended period of time (usually up to a year) at which time it is summarized and the details are archived. During the time that the prices are recorded in the central database they can be displayed and compared to the prices collected for the same product from other electronic marketplaces or various other reports and charts can be generated.

In addition to monitoring product prices in electronic marketplaces, one embodiment of the present invention also allows for monitoring of “deal” prices. The “deal” price is defined as a short term price break posted for a product in an online or brick-and-mortar store. The methods of monitoring deal prices can vary and may include, but are not limited to, such methods as: API calls, web service calls, RSS feeds, screen scraping and human entry. The monitoring of deals is a process independent of the monitoring of retail product prices in electronic marketplaces and may be on-demand or cyclical. The identification of deal prices can also be governed by rule sets. In such an embodiment of the invention a product deal is identified based on configurable thresholds compared to an electronic marketplace price quote for the same product. Once identified, the deal is recorded in a central database for an extended period of time (up to a year) at which time it is summarized and the details are archived. Additional information such as deal source, deal link, deal duration, rebate amount, shipping cost etc. may be recorded along with the deal price. The purpose of monitoring and aggregating deal prices is to illustrate significant departures from the overall product price trend in any of the electronic marketplaces. Therefore, buyers and sellers in an electronic marketplace can be privy to major external influences on a product price.

Upon conclusion of one or more monitoring cycles, the present invention may either automatically or on demand create a set of charts and graphs for each monitored product depicting the progression of prices in each electronic marketplace over time. The generated charts and graphs would also depict deal prices if they were recorded for a particular product in the time period shown. The generated charts and graphs would resemble a stock chart and in an online (or a computer application) embodiment would allow further manipulation by the end user, such as: narrowing or expanding of the time period, selection/de-selection of one of the monitored electronic marketplaces, selection/de-selection of monitored products for comparison, selection/de-selection of deals etc.

Most importantly, the generated charts and graphs would help answer the questions of greatest interest to both buyers and sellers. For buyers, the questions posed earlier would be addressed as follows:
Am I getting the lowest price for a product?
   By virtue of being an open marketplace where prices are freely set by the users themselves, who are both buyers and sellers, it is safe to assume that electronic marketplaces will have prices that are on average on par or below those set by the leading online and brick-and-mortar stores. By inference, displaying retail product prices across one or more electronic marketplaces guarantees the ability to identify one of the lowest prices in the marketplace overall.
   Through monitoring and display of short-term price-breaks or “deals” additional guarantees are made to the buyer of the lowest price available.
Is this the right time to buy a product or should I wait?
   The charts and graphs that the present invention makes possible will illustrate price changes over a period of time. A steep downward trend might encourage the buyer to hold of and wait, while a flat or a slight downward trend might encourage him or her to go ahead with the purchase.
   A frequent occurrence of deals in a specified period of time might further encourage the buyer to hold of and wait for the proper opportunity to purchase a product.
Where can I get the lowest price?
   The charts and graphs that the present invention makes possible will illustrate the source of the price i.e. an electronic marketplace or a store offering a deal, if applicable. By the argument presented in the first point above, the price listed will be guaranteed to be one of the lowest prices in the marketplace overall. In addition to illustrating the price source the online (or a computer application) embodiment of the present invention would allow the user to also link to the source.
      For sellers, the questions posed earlier would be addressed as follows:
Where can I make the most on the sale of my products?
   It is safe to assume that electronic marketplaces are one of the easiest and most convenient outlets for the sale of products. Due to their popularity they guarantee exposure to millions of potential buyers. Also, due to the convenience of conducting sales (low listing fees, minimal rules and regulations, very low startup costs) they are often the only choice for an individual seller or small to medium-sized business. Thus, even though the pressure to sell at a lower price may be higher in an electronic marketplace than selling the same product through a brick-and-mortar outlet, the overall benefits are believed to be higher in an electronic marketplace. The present invention allows the seller to choose an electronic marketplace that nets the highest overall benefit for the sale of a product.
   Sellers can also use the deal listings as an opportunity to buy at deal prices and then sell at marketplace prices. This will make the nature of the prices monitored and presented through the present invention even more dynamic and relevant.
Is this the right time to sell my product or should I wait?
   As already described, the charts and graphs that the present invention makes possible will illustrate price changes over a period of time. They also give an indication of the supply and demand. A steep downward trend might discourage the seller due to oversupply and low demand, while a flat or a slight downward trend might encourage him or her to go ahead and post the product for sale, indicating that the product is still in demand.
   A frequent occurrence of deals in a specified period of time might further discourage the seller from entering the market for a particular product. Instead the seller may focus on products with very lo occurrence of posted deals.

### BRIEF DESCRIPTION OF THE SEVERAL VIEWS OF THE DRAWING

FIG. 1 is a diagram describing the embodiment of the invention as a price aggregation and presentation service that interacts with electronic marketplaces (data providers) and buyers/sellers (data consumers).

FIG. 2A is an example chart listing prices collected over a period of one month for a product listed at two electronic marketplaces. The references to actual companies in the chart are for illustrative purposes only and are not meant to indicate that any actual deals, products or prices were collected from these companies.

FIG. 2B is an example chart with a deal entry. The deal entry is short-termed, but it has an effect on the price listings in all marketplaces. The references to actual companies in the chart are for illustrative purposes only and are not meant to indicate that any actual deals, products or prices were collected from these companies.

FIG. 2C is an example chart with a steep downward curve. The references to actual companies in the chart are for illustrative purposes only and are not meant to indicate that any actual deals, products or prices were collected from these companies.

FIG. 2D is an example chart listing prices over a period of one month for three products listed at two electronic marketplaces. The references to actual companies in the chart are for illustrative purposes only and are not meant to indicate that any actual deals, products or prices were collected from these companies.

FIG. 2E is an example table listing prices over a period of several hours for a product listed at two electronic marketplaces with one deal. The references to actual companies in the chart are for illustrative purposes only and are not meant to indicate that any actual deals, products or prices were collected from these companies.

FIG. 3A is a logical diagram depicting the web-application embodiment of the present invention. Several major components of the web-application are shown.

FIG. 3B is a flowchart describing the price aggregation process for N electronic marketplaces where N is essentially any integer greater than 1.

### DETAILED DESCRIPTION OF THE INVENTION

The present invention is a novel system and method for aggregating product prices from multiple electronic marketplaces. The system relies on the existence of electronic marketplaces and preferably uses the Application Programming Interfaces (APIs) provided by the marketplaces themselves to collect the product and price data. The ultimate goal of the invention is to provide an instant and comprehensive picture of a product's fair value over time.

The present invention also contemplates that a service leveraging the method of aggregation of prices presented herein could combine the product price data with the price-break (or deal) data collected from regular online retail outlets for an unprecedented source of product pricing information for both sellers and buyers. In addition, the service could expand the information it collects from electronic marketplaces to ratings, opinions, photos etc. further enhancing the experience for both potential seller and buyer alike.

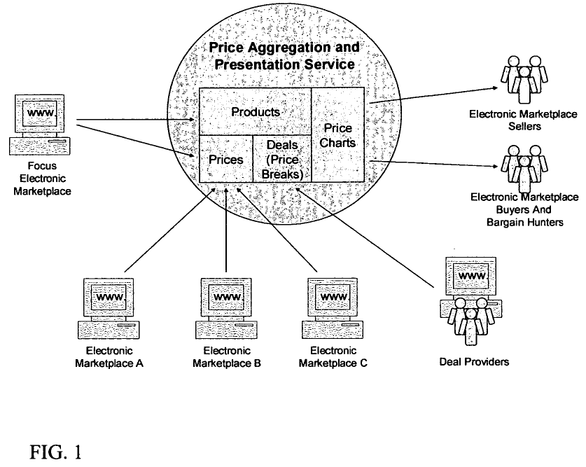

To illustrate features of the present invention relevant to aggregating data received from the electronic marketplaces, the present invention will be discussed in terms of a specific example. This example is based on a web application as the embodiment of the invention and two or three established electronic marketplaces that conduct auctions as well as mediate outright product sales between sellers and buyers. Furthermore, the electronic marketplaces in the example are assumed to provide APIs for remote access (over Internet) to their product and price databases. The principles of the present invention illustrated in the example can also be adapted to other invention embodiments (desktop application, client-server application, etc.) other types of marketplaces (non-mediated services) and other means of accessing their data (screen scraping, RSS feeds, human entry, etc.). Accordingly, the embodiments shown in the FIGS. 1 through 3, and described herein, should not be construed as limiting the invention to the specific embodiments shown and described.

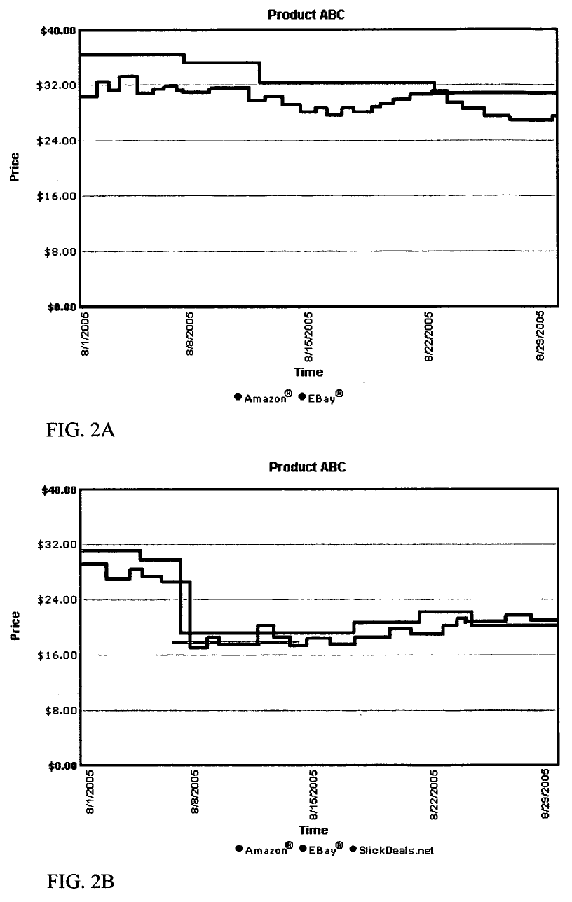

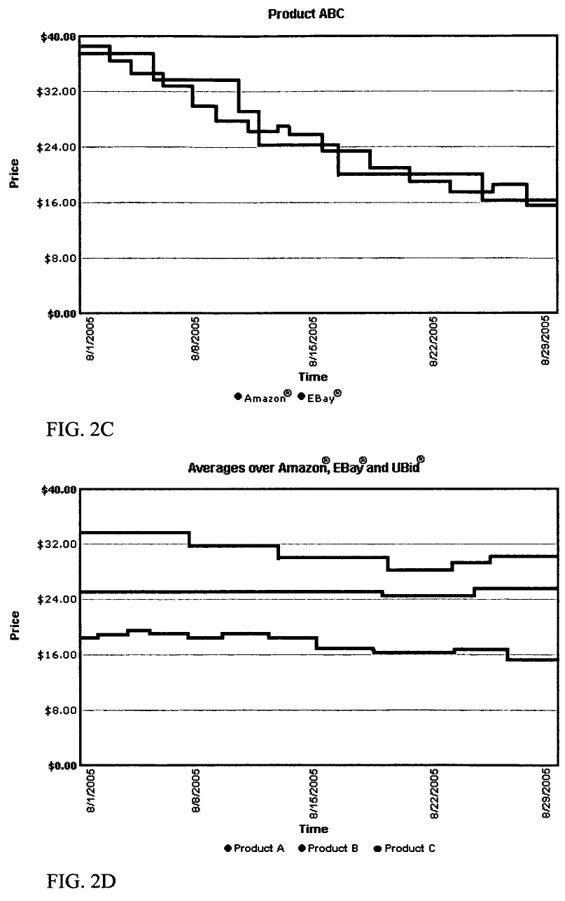

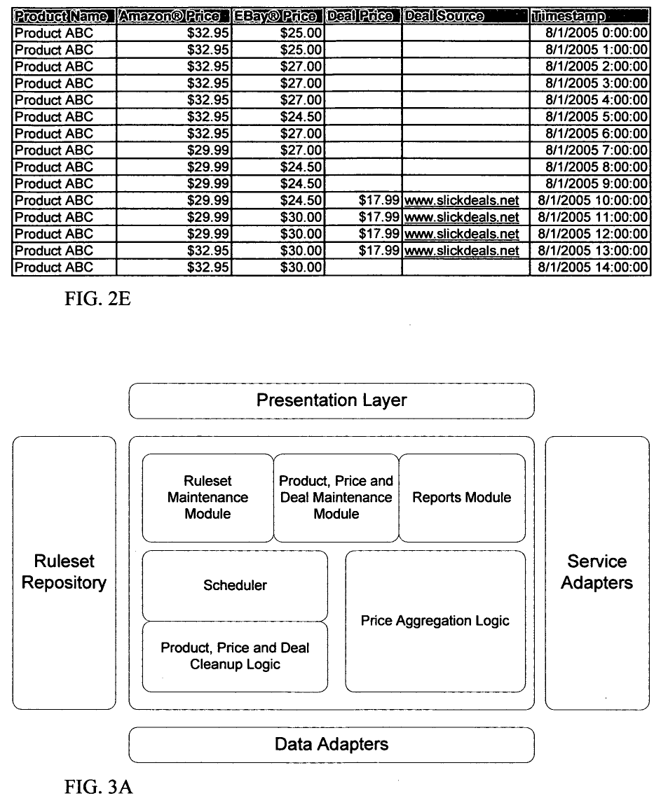

FIG. 1 describes the embodiment of the invention as a price aggregation and presentation service. As a service it interacts with multiple electronic marketplaces to collect product price data which it then processes in form of charts, graphs and other reports for consumption by its users. The users of the service are also the potential users of electronic marketplaces (both sellers and buyers) as well as individuals (bargain hunters) looking to understand the past or current fair value of a product. The main data that the service collects from electronic marketplaces is the data about products (product name, model, manufacturer as well as information pertaining to the particular electronic marketplace like category and unique identifiers) and prices (current lowest outright sale price and current highest bid, if applicable). A distinction is made between the focus electronic marketplace and other electronic marketplaces. Because different electronic marketplaces have different standards of naming products it would be very difficult to correlate the data gathered from all of them if there is not one product naming authority. Without an external product naming authority (which can be another embodiment of the invention) this embodiment selects one of the electronic marketplaces as the focus electronic marketplace that sets the product naming standards. Other electronic marketplaces are then evaluated against these standards. In addition to product and price information other information may also be collected from electronic marketplaces such as product photos, number of bids, time remaining in auction, sales ranks, ratings, opinions etc. The data collection is performed automatically by querying each electronic marketplace via a set of structured queries. The queries can take the form of API calls against services provided by the electronic marketplaces, SQL queries against their databases, consumption of an RSS feed provided by the electronic marketplaces or keyword-based searches collected from the website contents of the electronic marketplaces. In the preferred embodiment the service also collects data about product deals (deal price, deal source, deal expiration time and whether the deal requires a rebate). This data can be collected automatically from the web sites of online retailers, or also through manual entry via a user interface provided by the service itself. The service processes the collected product and price information (including deals) and presents it to the users in forms of charts, graphs and tables as illustrated by FIGS. 2A-2E.

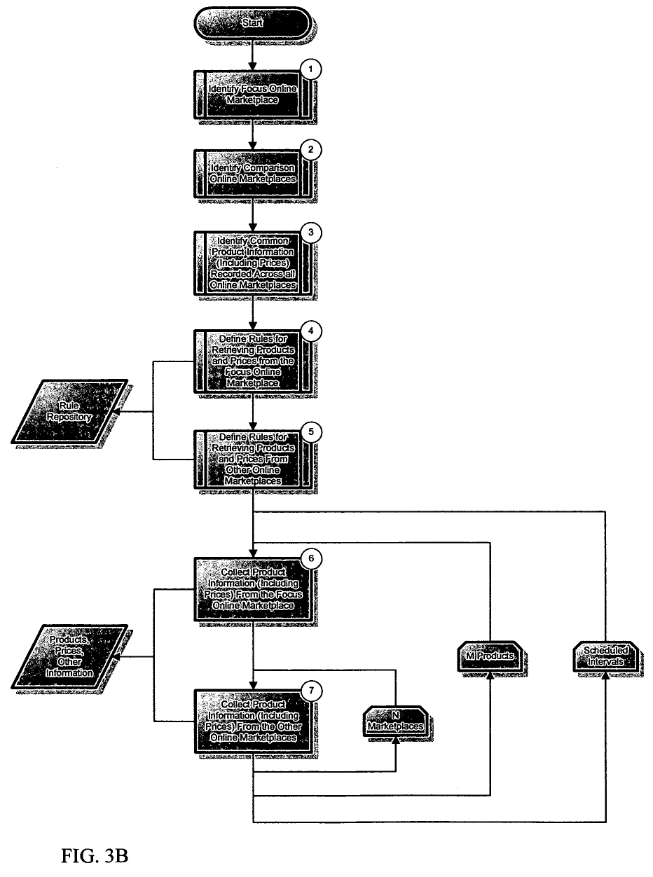

FIG. 3A illustrates the main components of the product and price aggregation and presentation service in an ideal embodiment.

The Scheduler component drives the frequency by which the service will collect prices from electronic marketplaces. The frequency should be adjustable with the lower limit being the total time required to retrieve prices from all targeted electronic marketplaces and the upper limit defined by the electronic marketplaces themselves (usually one hour). Every interval the Scheduler component kicks off the price collection algorithm defined by the Price Aggregation Logic component. Once the price aggregation process is kicked of, the Scheduler restarts the clock. This ensures that the prices presented to the users are up-to-date. The Scheduler component also drives the price cleanup process defined by the Product, Price and Deal Cleanup Logic component. This is done independently from the price collection process and with a much lower frequency (about once per day). This ensures that out-of-date or stale records of products and their prices and deals are removed from the system.

The Ruleset Maintenance Module component is used to maintain the rules by which the prices in electronic marketplaces are collected and interpreted. This component works directly with the Ruleset Repository component to store the rules. The rules themselves are to be entered and maintained by the administrators of the service. Each electronic marketplace may have its own set of rules. A rule could drive the way the prices are collected from a marketplace (e.g. take the highest bid in an item for which an auction expires in the next two hours) or the way they are interpreted (e.g. disregard collected prices that deviate more than 50% from the previously collected price from the same product in the same electronic marketplace). The rules are envisioned to be structured and parameterized logical sentences that can be easily modified. The Ruleset Maintenance Module component would therefore present a GUI (graphical user interface) to the service administrators where a proper set of sentences can be chosen for a particular electronic marketplace and individual parameters can be subsequently modified. This GUI would be accessed through the Presentation Layer component. All rules would be stored in the Ruleset Repository component where the Price Aggregation Logic component would read them during the process of price aggregation.

The Product, Price and Deal Maintenance Module component is used to maintain and make adjustments on electronic marketplaces, products, prices and deals that are stored in the system. In short, this component would drive all aspects of the service configuration. This task would also be performed by the service administrators. The tasks would include adding or removing electronic marketplaces for which prices are collected, adding or removing products for which prices are collected for individual electronic marketplaces, making adjustment to stored prices or entering product deal information. All information would be stored in a local database via the Data Adapters component. The Product, Price and Deal Maintenance Module component would also present a GUI that would allow all the configurations to be made. This GUI would be accessed through the Presentation Layer component. The various configurations made by the Product, Price and Deal Maintenance Module component would be used by other components like the Price Aggregation Logic component, Scheduler component, Reports Module component etc.

The Reports Module component is primarily used to present various charts, graphs and tables on the collected prices to the end users. The component would offer both canned reports as well as the ability to run ad-hoc reports against the collected data. The canned reports would be generated based on the most popular products (e.g. the price of iPod® over the last month). The ad-hoc reporting functionality of the Reports Module component would allow users to select products and time intervals of interest (see FIGS. 2A-2D). The component would retrieve product, price and deal data from the local database through the Data Adapters component and would be accessible through a GUI in the Presentation Layer component.

Product, Price and Deal Cleanup Logic component is used to remove outdated or stale products, prices and deals from the local database. It is triggered by the Scheduler component in regular intervals. The cleanup is performed by comparing deals to deal expiration dates, products to active products lists and prices to the configuration setting that determines how long should the prices be kept in the system. The component can either outright delete the data from the system, summarize it (by collapsing several price interval points into one) and archive it to another location, or set it to be inactive where it won't be visible to the users, but will remain in the local database. This component mainly operates on the local database through the use of the Data Adapters component.

Price Aggregation Logic component is the main component of the service. It is used to collect product and prices from multiple electronic marketplaces. It also uses many other components during the process of product and price aggregation. FIG. 3B depicts the overall service setup and execution process with steps 6 and 7 depicting the algorithm of product and price aggregation at a high level. The entire process will be described a couple of paragraphs below.

Ruleset Repository component—This component can be thought of as a database specializing in the storage and maintenance of business rules. New rules can be stored, old ones removed and the existing ones edited through a graphical user interface laid over the rules repository component. The rules are primarily read by the Price Aggregation Logic component.

Data Adapters component—This component, or a set of sub components, is used for access to the system's internal database. It governs how the data is to be written, edited or read from the internal database containing product, price, electronic marketplace and user information. It can be thought of as an abstract layer between the business logic components and the physical database. Such layering allows for easier database maintenance. Almost every other component uses the Data Adapters component.

Presentation Layer component—This component is used to render the graphical user interface (GUI) which will be used by external and internal users of the system alike to interface with other system components. The GUI may come in the form of a web page or a desktop application. It will allow users to specify parameters, enter additional content, or just view the charts produced by the system.

Service Adapters component—This component, or a set of sub components, is used for access to the internal databases of electronic marketplaces. Since electronic marketplaces may offer different ways to access their internal databases (API, web service, etc.) different components are needed to take advantage of these different avenues. The sub components would be created as generic classes which could then be instantiated as per the need of a specific marketplace. This component would be used by the Price Aggregation component in the process of product and price information aggregation.

Other components like security, content management, advertising etc. are not pictured but can be easily incorporated into the overall service design. The components depicted in FIG. 3A and described above are also not considered to be a novel idea, but their description helps to better understand one system embodiment of the present invention.

FIG. 3B depicts the overall service setup and execution process.

Step 1, the identification of the Focus Electronic marketplace is specific to this embodiment of the invention. As described earlier, this step is not necessary if a third-party product definition authority is used, if a distinct list of products is created and cross-linked to all electronic marketplaces, or if all the electronic marketplaces adhere to a standardized product naming and identification mechanism. As it currently stands each marketplace has a different product naming, tagging and identification mechanisms. In some electronic marketplaces the naming is left to the users who post their products for sale. The product naming/tagging is important because for a product to be searchable across multiple electronic marketplaces it needs to have something in common in each marketplace. The assumption made by this invention is that each marketplace employs some product naming/tagging scheme that allows a product to be searchable across electronic marketplaces. This embodiment of the invention relies of an identification of one electronic marketplace as the primary source of the product naming/tagging. Two main requirements for such a marketplace are that 1) it contains a large enough product base so that it overlaps with most of the products covered by other marketplaces and 2) its product naming/tagging is descriptive enough that specific keywords can be traced back to the same products in other marketplaces. The identification of the focus electronic marketplace is usually done once in the beginning and changes rarely (for example in case a better product naming source becomes available). The marketplace and its parameters (name, type, internet address etc.) are entered manually into the internal database.

Step 2 is usually done in conjunction with Step 1. It involves the identification of all the electronic marketplaces from which product and price information will be polled and compared. Identification of more marketplaces allows for a more confidence in the accuracy of the product's price and worth when presenting it to the users. This step is also usually done once in the beginning and changes rarely (for example in case a marketplace goes out of business or a new one opens or business). The marketplaces and their parameters (name, type, internet address etc.) are entered manually into the internal database.

Step 3 involves the identification of common product information (including prices) across all electronic marketplaces. This ensures that when electronic marketplaces are polled for information that the information that is gathered for products can be found in each of the electronic marketplaces. Consequently, a standard set of information can be presented to the users. This step is also usually done once in the beginning and changes rarely (for example if a piece of information becomes available among all marketplaces). The product parameters to be polled are entered manually into the internal database.

Step 4 involves defining rules for retrieving products and prices from the Focus Marketplace. This step is not required in case a third party product naming authority is used. The rules being defined in this step will govern how products and prices are to be interpreted and processed when retrieved from the focus electronic marketplace. Focus marketplace rules are particularly important because data gathered from it will be used in comparison with the data gathered from all other electronic marketplaces. Rule setup process involves entering parameters into structured sentences representing logical expressions. This step is usually done once in the beginning and changes rarely. Step 5 is similar to Step 4, but the rules are to be defined for every other electronic marketplace identified in step 2.

Step 6 is performed in scheduled intervals as set up via the scheduler component. It involves going through the list of products contained in the internal database of the focus marketplace. This step repeats for each product in the list. For each product in the list the product information identified in step 3 is retrieved and stored into the system's internal database according to the rules identified in step 4. Every scheduled interval the whole product list will be re-queried from the beginning. The data gathered during each run is saved and tagged with a timestamp. Some data may be cleaned up by the Product, Price and Deal Cleanup Logic Module as it becomes stale.

Step 7 is similar to step 6 except that it is performed for each of the electronic marketplaces identified in step 2. For each product processed in step 6 each of the electronic marketplaces is polled to a) identify the product in the internal database of the polled electronic marketplace b) collect the product information identified in step 3 and c) store it into the system's internal database according to the rules identified in step 5. The data is tagged and kept until it becomes stale at which point it is cleaned up. There may be cases where the marketplaces polled in this step contain products above and beyond those identified in the focus marketplace or they may be just named or tagged in such a way that they can't be linked to a same product in the focus electronic marketplace. For these cases the algorithm can be extended to add to the product list all such products. These added products will be processed after the products from the focus electronic marketplace have been processed in the same scheduled run. For each newly added product all electronic marketplaces identified in step 2 will be polled for product information.

What is claimed is:

1. An aggregation engine or system for use in aggregating product prices from multiple (essentially, more than one) electronic marketplaces comprising: a scheduler component, said scheduler component being configurable as to intervals at which the product information (including prices) will be aggregated from said electronic marketplaces; a ruleset repository and maintenance components, said components being used to define and store the rules and logic by which the said product prices for each of the said electronic marketplaces will be interpreted and stored; product and price aggregation and maintenance components, said components being used to retrieve said product information (including prices) from each of the said electronic marketplaces as well as maintain which of the said products, product information and electronic marketplaces will be queried; service adapter component, said component being used to connect to the systems or databases of each of the said electronic marketplaces; local database and data adapter components, said components being used to store, update or retrieve said product and price information retrieved from said electronic marketplaces; report component, said component being used to produce graphs, charts and other visual aides depicting product price trends over time, using the said product and price data retrieved from said electronic marketplaces; product and price cleanup component, said component used to summarize, archive or remove said product and price information collected from said electronic marketplaces and stored in the said local database after a configurable period of time.

2. A method for collection and aggregation of product prices across multiple (essentially, more than one) electronic marketplaces comprising the steps of:
a. Identifying a focus electronic marketplace
b. Identifying comparison electronic marketplaces that are different than the focus electronic marketplace identified in step a)
c. Identifying common product information for products listed in electronic marketplaces identified in steps a) and b), which has to include the product price
d. Identifying a set of processing rules for the focus electronic marketplace identified in step a) over the product information identified in step c)
e. Identifying a set of processing rules for each of the comparison electronic marketplaces identified in step b) over the product information identified in step c)
f Collecting product information identified in step c) for all the products listed in the electronic marketplace identified in step a) according to the set of rules identified in step d)
g. Collecting product information identified in step c) according to the set of rules identified in step e) from the electronic marketplaces identified in step b) for all the products listed in the electronic marketplace identified in step a) and cross-linked to products listed in the electronic marketplaces identified in step b) using matching product name keywords
h. Storing product information obtained through steps f) and g) in a database.

3. A method for collection and aggregation of product prices across multiple (essentially, more than one) electronic marketplaces comprising the steps of:
a. Identifying electronic marketplaces that will be queried for the product and price information
b. Retrieving all product names listed in the electronic marketplaces identified in step a)
c. Cross-linking the product names retrieved in step b) using matching product name keywords to create a comprehensive list of distinct products listed in electronic marketplaces identified in step a)
d. Identifying common product information for products listed in electronic marketplaces identified in step a), which has to include the product price
e. Identifying a set of processing rules for each of the electronic marketplaces identified in step a) containing the product information identified in step d)
f Collecting product information identified in step d) for all the products listed in the electronic marketplaces identified in step a) according to the set of rules identified in step e)
g. Storing product information obtained through step f) and cross-linked in step c) in a database.

4. A method as described in claim 2 (or alternatively, claim 3) where the electronic marketplaces queried for product information are auction type electronic marketplaces.

5. A method as described in claim 2, (or alternatively, claim 3) where the electronic marketplaces queried for product information are mediated product-listing type electronic marketplaces.

6. A method as described in claim 2 (or alternatively, claim 3) where the electronic marketplaces queried for product information are non-mediated product-listing type electronic marketplaces.

7. A method as described in claim 2 (or alternatively, claim 3) where the data collection from electronic marketplaces is performed via API calls.

8. A method as described in claim 2 (or alternatively, claim 3) where the data collection from electronic marketplaces is performed via consumption of RSS feeds offered by electronic marketplaces.

9. A method as described in claim 2 (or alternatively, claim 3) where the data collection from electronic marketplaces is performed via consumption of Web Services offered by electronic marketplaces.

10. A method as described in claim 2 (or alternatively, claim 3) where the data collection from electronic marketplaces is performed via ‘screen scraping’ of the electronic marketplace's web browser search results.

11. A method as described in claim 2 (or alternatively, claim 3) where the data collection from electronic marketplaces is performed via human efforts, through manual data entry using a graphical user interface.

12. A method as described in claim 2 (or alternatively, claim 3) where the collected product price information is displayed in a stock chart-like manner with the horizontal axis representing time and the vertical axis representing price and which displays data points (product prices) for one or more products collected from one or more electronic marketplaces over a period of time.

13. A method as described in claim 12 where one or more product price breaks (deals) collected independently of the electronic marketplaces are displayed along with the product price data points collected for one or more products from one or more electronic marketplaces.
